(19) United States
(12) Patent Application Publication
(10) Pub. No.: US 2022/0043681 A1
(43) Pub. Date: Feb. 10, 2022

(54) MEMORY USAGE PREDICTION FOR MACHINE LEARNING AND DEEP LEARNING MODELS

(71) Applicant: Oracle International Corporation, Redwood Shores, CA (US)

(72) Inventors: Ali Moharrer, San Jose, CA (US); Sandeep R. Agrawal, San Jose, CA (US); Venkatanathan Varadarajan, Seattle, WA (US); Sanjay Jinturkar, Santa Clara, CA (US); Nipun Agarwal, Saratoga, CA (US)

(21) Appl. No.: 16/985,116

(22) Filed: Aug. 4, 2020

(51) Int. Cl. G06F 9/50; G06N 5/04; G06K 9/62; G06N 20/00; G06T 1/20

(52) U.S. Cl. CPC G06F 9/5016; G06N 5/04; G06T 1/20; G06N 20/00; G06K 9/6231

(57) ABSTRACT

Herein, a computer receives a new training dataset for a target ML model. Proven or unproven respective values of hyperparameters of the target ML model are selected. An already-trained ML metamodel predicts an amount of memory that the target ML model will need, when configured with the respective values of the hyperparameters, to train with the new training dataset. In an embodiment, supervised training of the ML metamodel is as follows. The ML metamodel receives feature vectors that each contains distinct details of a respective past training of the target ML model of many and varied trainings of the target ML model. Those distinct details of each past training includes: respective values of the hyperparameters, and respective values of metafeatures of a respective training dataset of many training datasets. Each feature vector is labeled with a respective amount of memory that the target ML model needed during the respective past training.

### RELATED CASE

Incorporated by reference in its entirety herein is related U.S. patent application Ser. No. 15/914,883 “Using Meta-learning for Automatic Gradient-based Hyperparameter Optimization for Machine Learning and Deep Learning Models” filed Mar. 7, 2018 by Venkatanathan Varadaraj an et al.

### FIELD OF THE INVENTION

The present invention relates to predicting memory demand for machine learning (ML) model training. Herein are deep learning techniques that, through multidimensional nonlinear analysis, provide inferences of memory demand during training in a model-agnostic way.

### BACKGROUND

Use of machine learning (ML), such as deep learning, is rapidly spreading through industries and business units and is becoming a ubiquitous tool within some corporations. ML model training may be resource intensive of time and/or space of a computer. In almost all ML approaches, the main focus is to optimize the model to achieve a higher score or a lower loss value. A great deal of research also focuses on accelerating such algorithms. However, an issue that is often overlooked is how much memory these models will use during training. A computationally complex algorithm on a smaller machine or with fewer central processing unit (CPU) cores may be much slower but still will run to completion. However, a user may be unable to train an ML algorithm that requires more than available memory, in which case the memory (not CPU performance) becomes the main bottleneck in model training. This issue may become even more challenging for most real-world applications that deal with big data problems with ever-growing amounts of data.

Initial investigation shows that certain popular ML models can take up to 90 gigabytes (GB) of memory that can easily consume all available memory on smaller machines. Most of previous research focuses on deep learning (DL) models with large memory footprints and large multi-dimensional arrays that sometimes consist of millions (or even billions) of numeric parameters such as coefficients. The main focus in some approaches is on neural network model compression to store an already-trained neural model in systems with small memory capacity such as graphical processing units (GPU) and embedded systems with limited hardware resources. Known focus is on resource consumption during inference, which compared to training requires significantly less memory. Known lean approaches for neural network training rely on architecture-specific sparsity and micro-batching to reduce resource consumption during training. Overlooked is any possibility for generalized memory reduction for all ML algorithms including neural, non-neural, transparent internals, and opaque internals.

Metalearning entails training one ML metamodel to predict performance metric(s) of a target ML model. Recent research includes express skepticism that memory demand during training can be generally tamed by metalearning. Memory optimization introduces sharp discontinuities that are hard to model in various ML techniques. For example, a linear metamodel to predict memory usage cannot capture nonlinearities in complex ML algorithms. Known research is not general and instead is limited to a particular target ML model with a particular training dataset.

### BRIEF DESCRIPTION OF THE DRAWINGS

In the drawings:

FIG. 1 is a block diagram that depicts an example computer that uses an already-trained machine learning (ML) metamodel to predict how much memory will an untrained target ML model need, when configured with a selected hyperparameters configuration, to train with a new training dataset;

FIG. 2 is a flow diagram that depicts an example computer process that uses an already-trained ML metamodel to predict how much memory will an untrained target ML model need, when configured with a selected hyperparameters configuration, to train with a new training dataset;

FIG. 3 is a block diagram that depicts an example computer that trains an ML metamodel to predict how much memory a target ML model will need for training with a new configuration and/or a new dataset;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The present invention relates to predicting memory demand for machine learning (ML) model training. Herein are deep learning techniques that, through multidimensional nonlinear analysis, provide inferences of memory demand during training in a model-agnostic way for previously unseen training datasets. Unlike other works that only focus on neural networks, approaches herein generalize to any ML algorithm as well as deep learning models. This is achieved using metalearning based approaches that can collect training performance metadata across a wide variety of ML algorithms and datasets for better generalization.

Unlike other works that use linear metamodels, trained herein are complex, nonlinear memory-usage metamodels that generalize well to previously unseen training datasets. Unlike other works that only consider a subset of model-specific hyperparameters for memory usage prediction for a particular ML algorithm, techniques herein use available information on all hyperparameters of any ML algorithm to predict memory usage for training. Because no knowledge of semantics of hyperparameters and no knowledge of architecture and use of a target ML algorithm is needed, this approach is future-proof to accommodate target ML algorithms not yet proposed. This approach has special benefit for exotic hardware and datasets such that the larger and more complex is a training dataset and/or the less memory does a coprocessor or embedded processor have, then the more important is predicting memory demand of training. For example, a trend toward offloading matrices to graphical processing units (GPU) favors memory demand forecasting for training.

Flexibility and generality of approaches herein facilitate speculative exploration of a multidimensional nonlinear problem space as discussed herein. The following flexibilities facilitate exploratory automation that finds a memory-optimal training configuration of a target ML model. Hyperparameter variability for any target ML algorithm entails systematic generation of hundreds of model-specific configurations. Observing memory consumption of so many alternative configurations of the target ML model provides ample automatically-acquired insight into how hyperparameters of the target ML model can be tuned to need less training memory.

Dataset variability across a large corpus of training datasets that cover a wide variety of dataset shapes provide better generalization for an ML metamodel that learns to predict memory usage of the target ML model in training. Such dataset variability provides additional future-proofing to accommodate new data and to accommodate training the target ML model with a local dataset such as with private data such as on a personal device without exposing data to a communication network. For example, approaches herein can be used to select a target ML model, and its hyperparameter configuration, that is predicted to be trainable within a specified memory limit such as for a GPU or a mobile device. For example, selecting a wrong ML model and configuration may cause training to crash when memory is exhausted and after needlessly depleting battery charge.

Approaches herein generate a predictive ML metamodel for any ML or deep learning algorithm. The ML metamodel is trained on a special metadataset, as generated herein, that is used to predict the memory usage of the ML algorithm on any given new training dataset and for any proven or unproven hyperparameter configuration. It does not matter whether the target ML model is designed for classification, numeric regression, or other inferential function.

The process herein of metalearning-based memory usage prediction consists of the following two stages:
1. Offline training: generating the metadataset by repeatedly reconfiguring and retraining the target ML model, and subsequently training the ML metamodel with the metadataset;
2. Online inferencing: memory usage prediction of the target ML model for a new training dataset.

The offline training stage consists of gathering memory usage metadata across multiple dimensions. The goal is to gather sufficient information on memory usage values across a variety of hyperparameter values and dataset shapes. The gathered metadataset is then used for training the ML metamodel. During the inference stage, given the ML algorithm and a new dataset, the already-trained metamodel is loaded and can be used to predict the memory usage of various new training runs.

In an embodiment, a computer receives a new training dataset for a target ML model. Proven or unproven respective values of hyperparameters of the target ML model are selected. An already-trained ML metamodel predicts an amount of memory that the target ML model will need, when configured with the respective values of the hyperparameters, to train with the new training dataset.

In an embodiment, supervised training of the ML metamodel is as follows. The ML metamodel receives feature vectors that each contains distinct details of a respective past training of the target ML model of many and varied trainings of the target ML model. Those distinct details of each past training includes: respective values of the hyperparameters, and respective values of metafeatures of a respective training dataset of many training datasets. Each feature vector is labeled with a respective amount of memory that the target ML model needed, as empirically observed, during the respective past training.

### 1.0 Example Computer

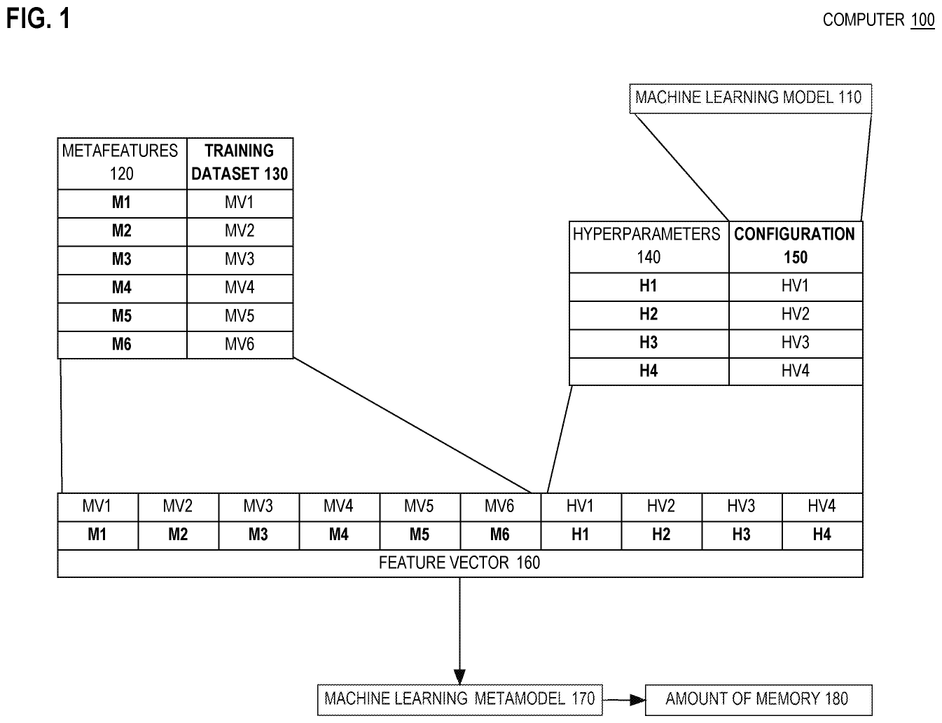

FIG. 1 is a block diagram that depicts an example computer 100, in an embodiment. Computer 100 uses already-trained machine learning (ML) metamodel 170 to predict how much memory will untrained ML model 110 need, when configured with hyperparameters configuration 150, to train with new training dataset 130. Computer 100 may be one or more of a rack server such as a blade, a personal computer, a mainframe, a virtual computer, or other computing device.

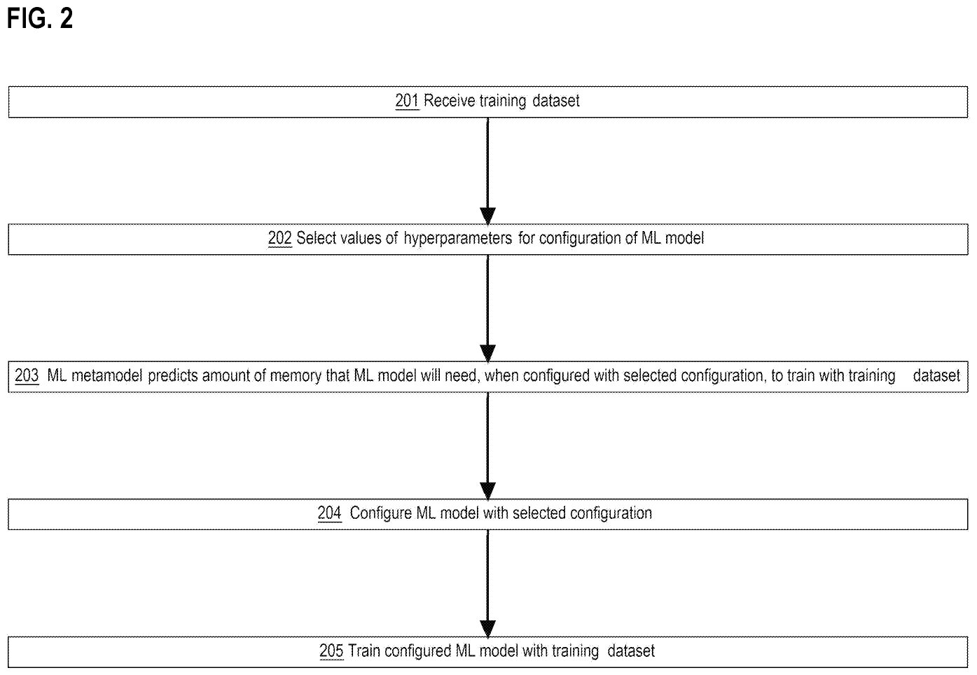

Computer 100 stores already-trained ML metamodel 170 in memory. For prediction as presented in FIGS. 1-2, computer 100 need not store, nor otherwise have available, ML model 110. ML metamodel 170 performs nonlinear regression as described later herein.

Depending on the embodiment, ML model 110 is designed for clustering, classification, regression, anomaly detection, prediction, or dimensionality reduction (i.e. simplification). Examples of machine learning algorithms for ML model 110 and/or ML metamodel 170 include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, or hierarchical and/or associative data structures.

Hyperparameterized (i.e. configurable) implementations of best of breed machine learning algorithms may be found in open source libraries such as scikit-learn (sklearn), Google's TensorFlow for Python and C++, or Georgia Institute of Technology's MLPack for C++. Shogun is an open source C++ ML library with adapters for several programing languages including C#, Ruby, Lua, Java, MatLab, R, and Python.

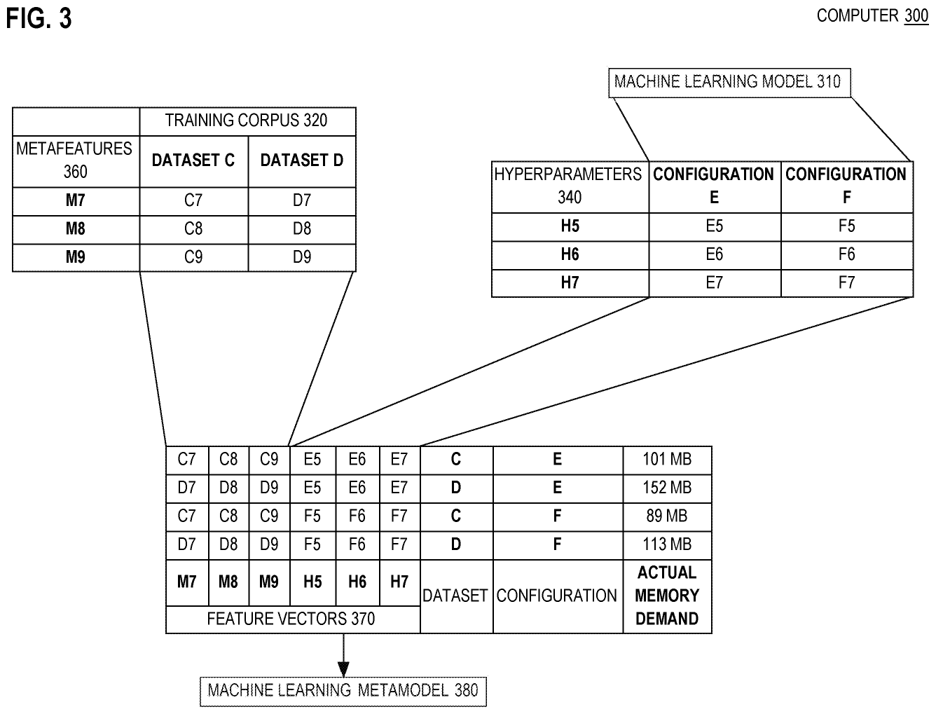

The lifecycles of ML model 110 and ML metamodel 170 have a same two phases. As presented later in FIG. 3 for untrained ML metamodel 170, the first phase is preparatory and entails training, such as in a laboratory or in the wild such as on a smartphone. As shown in FIGS. 1-2 for already-trained metamodel 170, the second phase entails inferencing in a production environment or a smartphone, such as with live and/or streaming data or with local, private, and/or personal historic data such as activity, usage, and/or preference data.

In FIGS. 1-2, ML model 110 may have previously been trained with some training dataset(s), but has not trained with new training dataset 130 such that same ML model 110 may be treated as trained or untrained. If ML model 110 is already trained, ML model 110 may be applied, during inferencing, to a (e.g. unfamiliar) sample (not shown), which may be injected as input into ML model 110. That causes ML model 110 to process the sample according to the internal mechanisms of ML model 110, which are specially tuned according to reinforcement learning by ML model 110 during training. Herein, a sample in a dataset may also be known as an example.

For example if ML model 110 is a classifier, then ML model 110 may select one of multiple mutually exclusive labels (i.e. classifications) for the sample, such as hot or cold. For example, ML model 110 may be applied to an outdoor photograph to infer whether the photo depicts hot weather or cold weather. Training ML model 110 entails: a) applying ML model 110 to a training corpus that contains at least one training dataset, such as new training dataset 130, that contains many photos, b) measuring error of training inferences made by ML model 110, and c) adjusting coefficients or other variables within ML model 110 to increase inference accuracy by reducing training error. Training of ML metamodel 170 does not entail tangible samples such as photos and is presented later with FIG. 3.

Depending on how rich (i.e. multidimensional) are sample data, there may be many (e.g. hundreds or thousands) of features that may have respective values for each sample in training dataset 130. ML model 110 may have one of many ML model types, and those model types typically have ample logical flexibility to accept and process many features of sample data. However, consumption of resources such as time and/or space may be positively correlated with the numerosity or complexity of available features.

For example, depending on the nature and contents of training dataset 130, computer 100 may have insufficient volatile or virtual memory to train ML model 110. For example, training dataset 130 may contain at least two million samples. For example, training may crash when computer 100 or another training computer runs out of memory during training of ML model 110.

It may be useful to predict how much memory does ML model 110 need to train with training dataset 130. For example, training may be accelerated when delegated to a coprocessor such as a graphical processing unit (GPU). Such delegation should not be attempted if ML metamodel 170 predicts that amount of memory 180 needed to train ML model 110 exceeds memory available to the GPU. In that case, training may instead be feasibly performed on a central processing unit (CPU) even though training occurs faster on a GPU.

Likewise, there may be many instances of ML model 110, such as one per end user, that each needs to be individually trained such as when each end user provides a separate and differentiated instance of training dataset 130. In that case, training is accelerated if each instance of ML model 110 is separately trained on the respective end user's client device such as a laptop or smartphone. For example, all model instances may be simultaneously trained due to natural horizontal scaling because each model instance has its own client device. Whereas centralized training of all model instances, one at a time, on a shared server may be temporally infeasible.

However, many smartphones and some laptops may have insufficient memory, which predicted amount of memory 180 may reveal without needing to attempt training on all client devices. For example, already-trained identical instances of ML metamodel 170 may be respectively deployed on all client devices. For example as a preface to training ML model 110, all client devices may locally invoke a respective instance of ML metamodel 170 to predict amount of memory 180. A subset of client devices that have more memory than predicted amount of memory 180 may locally train their respective instance of ML model 110. Another subset of client devices that have insufficient memory by comparison to predicted amount of memory 180 may, as a fallback strategy, delegate training of their respective instances of ML model 110 to the central server.

Each client device may need a separate prediction of amount of memory 180 because each client device may have a slightly or vastly different instance of training dataset 130 that may cause differences in predicted amount of memory 180. It does not matter whether predicted amount of memory 180 and ML metamodel 170 reside on all client devices or only on the central server. For example, there may be only one central instance of ML metamodel 170 to which client devices may delegate prediction of respective amounts of memory 180.

The complexity of the feature space with respect to a given training dataset such as 130 may be infeasible to directly analyze to predict needed amount of memory 180. It may be more tractable to instead analyze statistics of training dataset 130 as a whole rather than all of the values of all of the features of all of the samples in training dataset 130, such as when there are at least two thousand features for which each sample may have its own respective values. Such analyzable statistics and metadata that describe similar training datasets such as 130 are shown as metafeatures 120 that include metafeatures M1-M6.

All datasets in a same training corpus have respective values of a same set of metafeatures such as 120. Differences in values of metafeatures M1-M6 between different training datasets may cause slight or vast differences in respective amounts of memory needed to train same ML model 110 with the different training datasets, which ML metamodel 170 may be trained to more or less accurately predict.

The following are example metafeatures that metafeatures 120 may include. Metafeatures marked below as “classification only” are only included if ML model 110 is a classifier (e.g. not a regression).
Number of instances/data points (i.e. samples) in the dataset (n_instances);
Number of features in the dataset (n_features);
Dimensionality: n_features/n_instances
Number of categorical/non-numeric features in the dataset;
Number of numeric features in the dataset;
Number of classes in dataset (classification only);
Number of instances for the least common class (minority_class_size) (classification only);
Number of instances for the most common class (majority_class_size) (classification only); and
minority_class_size/majority_class_size (classification only).

The above enumerated example metafeatures are somewhat generic such that they do not depend on the nature of the training dataset. For example, a dataset of photos and a dataset of text documents should not occur in a same training corpus but may still have some or all of the above example metafeatures. Other metafeatures may instead be based on the nature of the dataset. For example, a photographic dataset may have specialized metafeatures such as average count of pixels per photo, total count of pixels in the dataset, and maximum amount of colors in a most colorful photo in the dataset. Metafeature approaches are presented in related U.S. patent application Ser. No. 15/914,883.

Another important factor that affects how much memory is needed to train ML model 110 is the configuration of ML model 110 itself. Before training, ML model 110 may be configurable according to many alternative configurations such as 150 such that training same ML model 110 with same training dataset 130 may need very different amounts of memory depending on which alternative configuration of ML model 110 is used. All of the alternative configurations such as 150 contain a distinct combination of values for a same set of hyperparameters 140 that includes many hyperparameters such as H1-H4. As shown, configuration 150 has respective values HV1-4 for hyperparameters H1-4.

Which hyperparameters does hyperparameters 140 contain depends on what kind of ML model is ML model 110 and which implementation toolkit is ML model 110 based on. For example a neural network has different hyperparameters than a random forest. Likewise, a neural network implemented with Keras may have different hyperparameters than a similar neural network implemented with PyTorch even though both are python implementations.

For example, neural network hyperparameters may include: a count of layers, a count of neurons per layer, activation function, learning rate, and batch size. Example random forest hyperparameters may include: number of trees in the forest, maximum number of features considered for splitting a node, number of levels in each decision tree, minimum number of data points on a leaf node, and method for sampling data points.

Each hyperparameter adds a degree of freedom for configuring ML model 110 such that well configuring ML model 110 may entail multidimensional optimization. Some hyperparameters may have continuous numeric ranges, which makes the multidimensional configuration space contain a nearly infinite amount of combinations of hyperparameters values. Thus, configuration 150 may be one of an almost unlimited amount of alternative configurations for same ML model 110, and each alternative configuration may need a slightly or vastly different amount of memory for training ML model 110, which ML metamodel 170 may be trained to more or less accurately predict.

In operation, ML metamodel 170 may analyze values of metafeatures 120 of training dataset 130 and values of hyperparameters 140 of configuration 150 to predict amount of memory 180 that ML model 110 will need, when configured with configuration 150, to train with training dataset 130. Such prediction by already-trained ML metamodel 170 is an inference because training dataset 130 may be a new and never-before used dataset and/or configuration 150 may be a new and never-before used configuration. In other words, ML model 110 may have previously trained only with other datasets and/or other configurations.

Thus, training dataset 130 and/or configuration 150 may contain novel values or at least novel combinations of values that occur in various other datasets and/or configurations. Thus, inferencing by ML metamodel 170 may entail interpolation and/or extrapolation to predict needed amount of memory 180 based on training dataset 130 and configuration 150.

In operation, metafeature values MV1-6 and hyperparameter values HV1-4 are stored into feature vector 160 that ML metamodel 170 accepts as input from which to predict amount of memory 180. In operation, feature vector 160 is all that already-trained ML metamodel 170 needs to predict amount of memory 180. For example, training dataset 130 need not exist, and metafeature values MV1-MV6 may be synthesized such as randomly or algorithmically. Likewise, configuration 150 and its hyperparameter values HV1-4 may be speculatively generated without any commitment to eventually configure ML model 110 with configuration 150.

To the vast multidimensional problem space (not shown) of distinct potential instances of feature vector 160 may, to conceptually form a multidimensional solution space, be added memory demand as an extra dimension that is a dependent variable for how much memory would training with each feature vector point in the problem space need. Two factors may confound correlation of the solution space with the problem space.

One confounding factor is any element of feature vector 160 that is categorical. A metafeature or a hyperparameter may be categorical. Some categories are meaningfully encoded as integers. For example, metafeature M1 may be a calendar month when all photos in training dataset 130 were taken, which may be originally represented as strings but meaningfully encoded as enumerated ordinals that are zero or one based such as 1 for January and 2 for February such that natural sorting of the ordinals from 1 to 12 matches the natural sequence of months from January to December. Such meaningful enumeration retains original semantics such as seasonality such that winter or a first annual quarter is conveniently defined by a subrange of encoded months 1-3.

However, ordinals provide no meaning to some other categories. For example, hyperparameter H1 may be neural activation function with five predefined choices of sigmoid, hyperbolic tangent (Tan H), rectified linear unit (ReLU), softmax, and swish. In that case, enumerating those five choices will not retain any semantics of the choices, and the category causes nonlinearity in the solution space. To some extent, one-hot encoding into five mutually exclusive binary features may mitigate but not eliminate nonlinearity.

Another confounding factor is any boundary condition in the ML implementation software that affects memory demand such as memory allocation granularity, coefficient matrix resizing such as during initial loading, and/or memory heap size. Thus, various factors may cause the solution space of actual or predicted memory demand to have various nonlinearities. As such, ML metamodel 170 is more accurate if capable of nonlinear regression for predictions.

In any case, varied instances of feature vector 160 may be used to infer various amounts of memory 180 by ML metamodel 170 for exploration of the solution space. For example, instances of feature vector 160 based on many different configurations such as 150 may be quickly and superficially evaluated by ML metamodel 170 without involving expensive training of ML model 110. For example to suit various device profiles having various amounts of memory, different configurations such as 150 may, based on their predicted amounts of memory 180, become selected as more promising than others, which subsequent training of ML model 110 may empirically confirm. By such reduction in the amount of experimental configurations actually trained with to a promising few, discovery of superior configurations may be accelerated to save time and, especially with a battery-powered mobile device with local training dataset 130 that is private and personal, accelerated to save electricity.

Various confirmed configurations may subsequently be designated as preferred for respective device profiles. For example, due to increased training accuracy or decreased training time or robustness over divergent datasets, configuration 150 may be ideal for a powerful laptop. Whereas due to lower memory demand, another configuration for same ML model 110 may be ideal for a resource-constrained smartphone.

### 2.0 Predictive Inferencing

FIG. 2 is a flow diagram that depicts an example process that computer 100 may perform using ML metamodel 170 to predict amount of memory 180 that will be needed to train ML model 110, when configured with configuration 150, with training dataset 130. FIG. 2 is discussed with reference to FIG. 1.

Steps 201-202 may occur in the shown ordering or reversed. Step 201 receives training dataset 130 such as contained in a spreadsheet, in a relational database table, in a console output log, or in file(s). If training dataset 130 is new, then ML model 110 has never trained with dataset 130. Otherwise, configuration 150 may be new such as experimental even though training dataset 130 is not new.

Step 202 selects values of hyperparameters 140 for configuration 150 for ML model 110. Step 202 may randomly generate values, may reuse recently discovered superior-performing values, may use default values such as provided by the implementation software for ML model 110, may use values along regular intervals in each hyperparameter's range, or some combination of those. In some examples, configuration 150 is already established and training dataset 130 is new, or a developer or software application provides configuration 150 according to any heuristic.

In step 203, already-trained ML metamodel 170 predicts amount of memory 180 that ML model 110 will need, when configured with configuration 150, to train with training dataset 130. Amount of memory 180 is an inference by ML metamodel 170 in response to receiving feature vector 160. Step 203 has very low latency, such as humanly imperceptible.

Steps 204-205 are optional such that some embodiments or scenarios do not proceed beyond step 203. The following scenarios A-B may additionally perform both steps 204-205. A goal of scenario A is to directly ready ML model 110 for production deployment and/or use. A goal of scenario B is to empirically confirm, by actual training of ML model 110 with configuration 150 and training dataset 130, that predicted amount of memory 180 is accurate.

Step 204 is identical for scenarios A-B. Step 204 configures or reconfigures ML model 110 with configuration 150. For example, ML model 110 may reside in volatile memory of computer 100 or another computer. For example, ML model 110 and ML metamodel 170 may be hosted by same or different computers. If ML model 110 were already differently configured and/or trained, both of the learned weights and the old configuration are overwritten within ML model 110 so that ML model 110 is ready for training or retraining. In an embodiment, reconfiguring entails discarding a previous instance of ML model 110 and generating a new instance of ML model 110 based on configuration 150.

Step 205 also is identical for scenarios A-B. However, what activity follows step 205 depends on which scenario. Step 205 trains configured ML model 110 with training dataset 130. Step 205 may use known training techniques such as reinforcement learning, gradient optimization, backpropagation, and/or mathematical or other fitting. In an embodiment, training ML model 110 is black-box such that step 205 only submits dataset 130 to a training routine of ML model 110 and waits for training to complete.

In some embodiments, all of steps 201-205 occur on a client device such as a smartphone that is computer 100. In some embodiments, steps 201-203 occur on computer 100 that hosts ML metamodel 170, and steps 204-205 occur on a GPU, which hosts ML model 110, that may or may not be contained in computer 100. In some embodiments, steps 201-202 occur on computer 100, and steps 203-205 occur on a GPU that hosts both ML model 110 and ML metamodel 170. Any of those embodiments may or may not perform steps 204-205 as discussed above.

After step 205, scenario A may or may not package, publish, and/or deploy trained ML model 110 into a production environment that may or may not include computer 100. In any case after step 205, scenario A eventually activates trained ML model 110 to cause a production inference of a nature based on the nature and application of ML model 110. For example, ML model 110 may predict and suggest that the end user should next play a particular stored song, such as when computer 100 is an MP3 player that locally trained ML model 110 based on private and personal listening history logged as training dataset 130.

After step 205, scenario B may archive or discard any enumerated artifacts of: ML model 110, configuration 150, predicted amount of memory 180, actual amount of memory needed, and/or identity or contents of training dataset 130. For example, configuration 150 may be experimental and appear desirable before steps 204-205, and which of those enumerated artifacts are archived or discarded may or may not depend on how similar or dissimilar are predicted amount of memory 180 and the actual amount of memory needed as empirically observed during step 205. In an embodiment, when predicted amount of memory 180 appears undesirable, steps 204-205 do not occur, and only a subset of those enumerated artifacts are available, any of which may be archived or discarded, such as based on predicted amount of memory 180 and/or training dataset 130. An embodiment that records the actual amount of memory needed may also record other empirically observed metrics such as training duration and/or training accuracy.

### 3.0 Example Training Architecture

FIG. 3 is a block diagram that depicts an example computer 300, in an embodiment. Computer 300 trains ML metamodel 380 to predict how much memory ML model 310 will need for training with a new configuration and/or a new dataset. Computer 300 may or may not be an implementation of computer 100.

ML model 310 is not an implementation of ML model 110 because both ML models 110 and 310 have different respective hyperparameters 140 and 340. ML models 110 and 310 may or may not be architecturally very different such as a neural network and a support vector machine (SVM). ML models 110 and 310 may or may not be functionally very different such as a linear regression and a classifier.

Despite such major differences between ML models 110 and 310, ML metamodels 170 and 380 are functionally similar predictive models and may or may not be architecturally similar such as both being somewhat similar neural networks. In any case and as shown, ML metamodels 170 and 380 accept feature vectors of different respective widths. For example as shown, feature vector 160 has a width of ten values, and each of feature vectors 370 has a width of six values.

As shown, feature vectors 370 contains four distinct feature vectors for various distinct training combinations for ML model 310 that are combinations of datasets C-D and configurations E-F. Configurations E-F are also known herein as configuration tuples. As shown, the combinations are exhaustive.

In a non-exhaustive example for same datasets C-D and configurations E-F, feature vectors 370 would have fewer feature vectors. A practical example would have many more configurations than E-F, even when hyperparameters 340 has same hyperparameters H5-7. For example, more than 200 configurations may be used to train ML model 310 during solution space exploration. Exploratory metamodel approaches are presented in related U.S. patent application Ser. No. 15/914,883.

Shown adjacent to the right edge of feature vectors 370 are additional columns for dataset, configuration, and actual memory demand. Those additional columns are not part of feature vectors 370. The dataset and configuration columns are demonstrative. The actual memory demand column contains respective labels for each feature vector.

That is, each of feature vectors 370 specifies a training of ML model 310 that actually occurred, and the label for actual memory demand is how much memory was actually needed as empirically observed during training. Thus, feature vectors 370 are a very few points in the problem space, such that even ten thousand feature vectors would only be a tiny fraction of the problem space. Likewise, feature vectors 370 as labeled with the actual memory demand column are a very few points in the solution space.

Those thousands of points, which are the labeled feature vectors 370, in the solution space are the training corpus for ML metamodel 380. Training of ML metamodel 380 is supervised regardless of whether training of ML model 310 is supervised or unsupervised.

The following unified embodiment has both of ML metamodels 170 and 380 but is somewhat different than shown. In the unified embodiment: a) metafeatures 120 and 360 are a same set of metafeatures, and b) ML models 110 and 310 share a same training corpus. Thus, ML models 110 and 310 may train with a same set of feature vectors that are derived from the shared training corpus. Thus, ML models 110 and 310 train with identical inputs that are a same small part of a same multidimensional problem space.

In the unified embodiment, ML models 110 and 310 are functionally identical such that both are classifiers or both are nonlinear regressions, etc. ML models 110 and 310 are architecturally different. For example, ML model 110 may be a neural network, and ML model 310 may be a support vector machine. Thus, types and amounts of hyperparameters 140 and 340 may be very different. For example, hyperparameters 140 and 340 may be disjoint (i.e. non-intersecting) sets. Thus for ML metamodels 170 and 380, the feature vectors, the problem space, the empirically observed memory consumption during training, and the solution space may be very different because one is based on ML model 110 and the other is based on ML model 310 that is very different.

After ML metamodels 170 and 380 are trained and ready for production inferencing, a new training dataset may be received that ML models 110 and 310 can share. However even before training with the new dataset begins, ML metamodels 170 and 380 can predict how much memory do respective ML models 110 and 310 need to train with the new dataset based on various configurations of ML models 110 and 310. Based on those predictions, a computer may detect which of ML models 110 and 310 needs less training memory and whether one or both of ML models 110 and 310 can be trained within some memory limit.

Thus based on those predictions, the computer may select which one of ML models 110 and 310 to train with the new dataset. Thus, no time and electricity are wasted by training the unselected one of ML models 110 and 310 with the new dataset. In that way, the computer can optimally switch between models 110 and 310 whenever another new training dataset arrives, such as when an old dataset is expanded with additional recent data.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

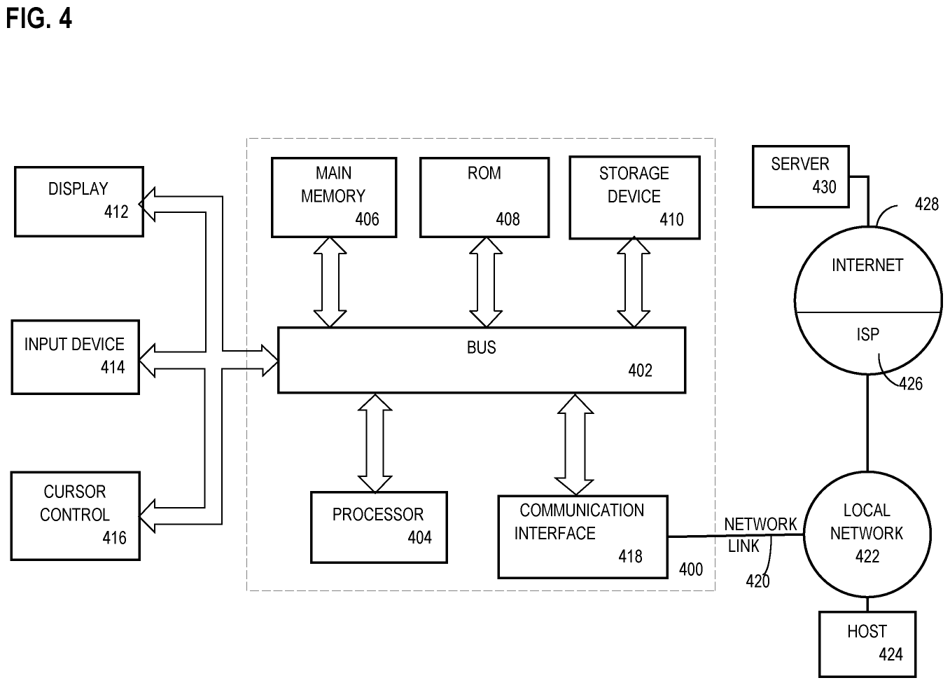

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

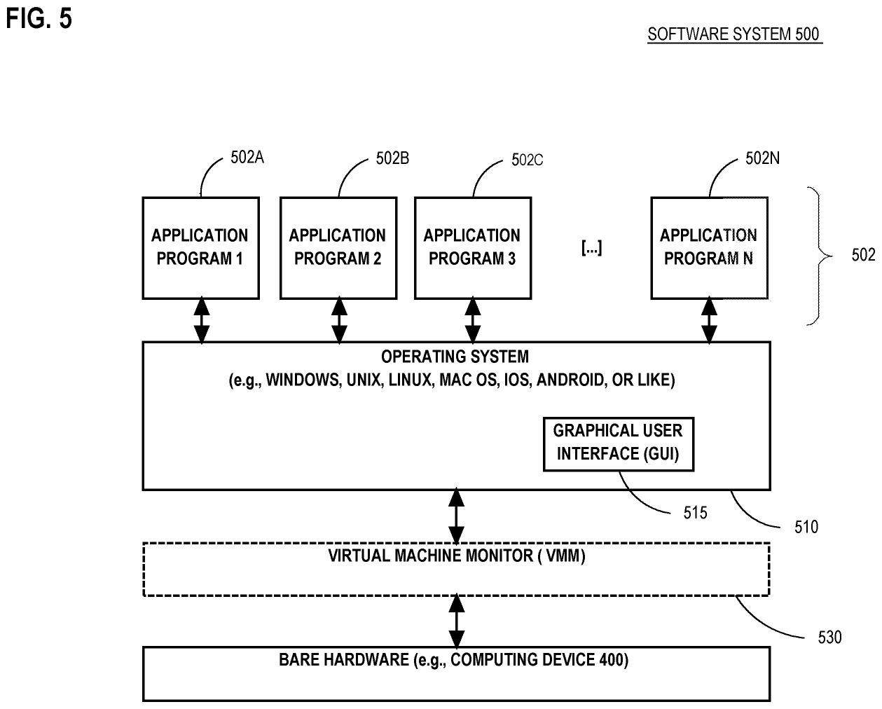

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, executed, and/or as generating an output or predication, a computer system process executing a machine learning algorithm applies the model artifact against the input to generate a predicted output. A computer system process executes a machine learning algorithm by executing software configured to cause execution of the algorithm.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature F2ootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving a new training dataset;
selecting respective values of a plurality of hyperparameters of a machine learning (ML) model;
predicting, by an ML metamodel, an amount of memory that said ML model will need, when configured with said respective values of the plurality of hyperparameters, to train with said new training dataset.

2. The method of claim 1 wherein said predicting said amount of memory that said ML model will need to train with said new training dataset is based on respective values of a plurality of metafeatures of said new training dataset.

3. The method of claim 2 wherein said predicting based on said respective values of said plurality of metafeatures comprises said ML metamodel receiving a feature vector that contains: said respective values of said plurality of metafeatures and said respective values of the plurality of hyperparameters.

4. The method of claim 2 wherein:
the method further comprises supervised training said ML metamodel by said ML metamodel receiving a plurality of feature vectors that each contains distinct details of a respective past training of said ML model of a plurality of trainings of said ML model;
said distinct details of each past training of said ML model includes:
respective values of said plurality of hyperparameters, and
respective values of said plurality of metafeatures of a respective training dataset of a plurality of training datasets that does not include the new training dataset;
each feature vector of said plurality of feature vectors is labeled with a respective amount of memory that said ML model needed during said respective past training.

5. The method of claim 1 further comprising supervised training said ML metamodel based on respective amounts of memory that said ML model needed to respectively train with each training dataset of a plurality of training datasets that does not include the new training dataset.

6. The method of claim 1 further comprising:
generating a plurality of distinct configuration tuples that each contain respective values of said plurality of hyperparameters;
supervised training said ML metamodel based on respective amounts of memory that said ML model needed, when respectively configured with each configuration tuple of said plurality of distinct configuration tuples, to respectively train with a particular training dataset that is not the new training dataset.

7. The method of claim 6 wherein said plurality of distinct configuration tuples contains at least two hundred configuration tuples.

8. The method of claim 1 further comprising:
deploying said ML model in a resource-constrained embedded environment;
training, in said resource-constrained embedded environment, said ML model with said new training dataset.

9. The method of claim 8 wherein said resource-constrained embedded environment is a graphical processing unit (GPU).

10. The method of claim 1 wherein said ML metamodel is nonlinear.

11. The method of claim 1 wherein:
said ML model is a first ML model;
said plurality of hyperparameters is a first plurality of hyperparameters of said first ML model that is not the same as a second plurality of hyperparameters of a second ML model;
said ML metamodel is a first ML metamodel;
said predicting said amount of memory is a first predicting a first amount of memory;
the method further comprises:
second predicting, by a second ML metamodel, a second amount of memory that said second ML model will need, when configured with respective values of the second plurality of hyperparameters, to train with same said new training dataset;
training a particular ML model selected, based on comparing said first amount of memory and said second amount of memory, from said first ML model and said second ML model.

12. The method of claim 11 wherein said first plurality of hyperparameters and said second plurality of hyperparameters are disjoint sets of hyperparameters.

13. The method of claim 1 wherein said new training dataset contains at least two million examples.

14. The method of claim 1 further comprising said ML model receiving a feature vector that contains respective values of at least two thousand features.

15. One or more computer-readable non-transitory media storing instructions that, when executed by one or more processors, cause:
receiving a new training dataset;
selecting respective values of a plurality of hyperparameters of a machine learning (ML) model;
predicting, by an ML metamodel, an amount of memory that said ML model will need, when configured with said respective values of the plurality of hyperparameters, to train with said new training dataset.

16. The one or more computer-readable non-transitory media of claim 15 wherein said predicting said amount of memory that said ML model will need to train with said new training dataset is based on respective values of a plurality of metafeatures of said new training dataset.

17. The one or more computer-readable non-transitory media of claim 16 wherein:
the instructions further cause supervised training said ML metamodel by said ML metamodel receiving a plurality of feature vectors that each contains distinct details of a respective past training of said ML model of a plurality of trainings of said ML model;
said distinct details of each past training of said ML model includes:
respective values of said plurality of hyperparameters, and
respective values of said plurality of metafeatures of a respective training dataset of a plurality of training datasets that does not include the new training dataset;
each feature vector of said plurality of feature vectors is labeled with a respective amount of memory that said ML model needed during said respective past training.

18. The one or more computer-readable non-transitory media of claim 15 wherein the instructions further cause:
generating a plurality of distinct configuration tuples that each contain respective values of said plurality of hyperparameters;
supervised training said ML metamodel based on respective amounts of memory that said ML model needed, when respectively configured with each configuration tuple of said plurality of distinct configuration tuples, to respectively train with a particular training dataset that is not the new training dataset.

19. The one or more computer-readable non-transitory media of claim 15 wherein the instructions further cause:
deploying said ML model in a resource-constrained embedded environment;
training, in said resource-constrained embedded environment, said ML model with said new training dataset.

20. The one or more computer-readable non-transitory media of claim 15 wherein:
said ML model is a first ML model;
said plurality of hyperparameters is a first plurality of hyperparameters of said first ML model that is not the same as a second plurality of hyperparameters of a second ML model;
said ML metamodel is a first ML metamodel;
said predicting said amount of memory is a first predicting a first amount of memory;
the instructions further cause:
second predicting, by a second ML metamodel, a second amount of memory that said second ML model will need, when configured with respective values of the second plurality of hyperparameters, to train with same said new training dataset;
training a particular ML model selected, based on comparing said first amount of memory and said second amount of memory, from said first ML model and said second ML model.
